(19) United States
(12) Patent Application Publication
(10) Pub. No.: US 2021/0300185 A1
(43) Pub. Date: Sep. 30, 2021

(54) CONNECTING UNIT FOR CONNECTION TO AN ELECTRIC VEHICLE

(71) Applicant: Siemens Aktiengesellschaft, Munchen (DE)

(72) Inventors: Sebastian Bode, Ahlen (DE); Anton Schmitt, Vaterstetten (DE); Jörg Heuer, Oberhaching (DE)

(21) Appl. No.: 16/316,114

(22) PCT Filed: Jun. 7, 2017
(86) PCT No.: PCT/EP2017/063806

§ 371 Date: Jan. 8, 2019

(30) Foreign Application Priority Data
Jul. 11, 2016 (DE) 10 2016 212 584.2

(51) Int. Cl. B60L 5/24; B60L 5/12; B60L 5/36; B60L 53/14; B60M 1/36

(52) U.S. Cl. CPC B60L 5/24; B60L 5/12; B60L 2200/18; B60L 53/14; B60M 1/36; B60L 5/36

(57) ABSTRACT

A connecting unit for connection to an electric vehicle with two or more contact rails is provided. By way of example, one contact rail is provided for the connection DC+ and one contact rail is provided for the connection DC−. These contact rails are dependent on one another to a certain degree on account of the positive and negative polarity. Therefore, the contact rails are not arranged in any desired manner, but rather at a specific distance from one another. Furthermore, the connecting unit has a further contact rail to which a signal can be applied. The contact rails can be connected to corresponding vehicle-side contact rails of the electric vehicle.

### CROSS-REFERENCE TO RELATED APPLICATIONS

This application claims priority to PCT Application No. PCT/EP2017/063806, having a filing date of Jun. 7, 2017, based off of German Application No. 10 2016 212 584.2, having a filing date of Jul. 11, 2016, the entire contents both of which are hereby incorporated by reference.

### FIELD OF TECHNOLOGY

The following relates to a connecting unit for connection to an electric vehicle an electric vehicle for connection to a connecting unit, and a corresponding method.

### BACKGROUND

Electromobility is a technology of the future, which is assuming increasing importance. It constitutes an important element of a climate-friendly energy and transport policy. As energy is provided by electric power, renewable energy sources can also be employed for mobility, thereby permitting virtually CO2-free transport. Charging infrastructures are therefore required for the efficient and economical charging of electric vehicles, for example electric cars or electric buses. Electric buses are also commonly described as “e-buses”.

A precondition for low-emission and energy-efficient local public transport using electric vehicles is a corresponding charging infrastructure. Charging infrastructures of this type are already known from the prior art.

A known charging infrastructure is customarily comprised of a combination of a control unit, a voltage source (e.g. a converter) and a charging point, to which a vehicle can be connected by means of a connecting unit. For example, pantographs are employed as the connecting unit of the charging infrastructure used in the charging process for electric buses, such as electrically-powered public buses. In other words, the electric vehicle is charged by means of the pantograph in a charging process.

From the prior art, solutions are known for the stationary charging of buses during stops which are necessary in any event (“opportunity charging”). The requisite electrical and IT connection for this purpose is provided by means of the pantograph.

FIG. 3 shows an exemplary charging infrastructure from the prior art, comprising a charging station for the charging of an electric bus by means of a pantograph. As already described, one part of the charging process involves the formation of a hard-wired connection between the electric vehicle 10 and the pantograph 20. To this end, it is firstly necessary for the electric vehicle 10 to be correctly geometrically positioned in relation to the pantograph 20. The electric vehicle 10 is arranged below the pantograph 20, and the pantograph 20 is then lowered in the direction of the electric vehicle 10. This process is also described as the positioning process, and precedes the actual charging process.

The electric vehicle 10 is connected to a pantograph 20 by means of four connections (DC+, DC−, PE, CP), as represented in FIG. 3. The electric vehicle 10 can be, for example, the abovementioned electric bus. For the formation of the requisite four connections, the electric vehicle 10 and the pantograph 20 respectively incorporate corresponding contact rails. The contact rails represented in FIG. 3 are rectangular in shape, and are indicated by shading. Correspondingly, the charging point for the electric vehicle 10 comprises a pantograph 20, to the end of which contact rails 21, 22, 23, 24 are fitted.

Four contact rails 11, 12, 13, 14 for the four connections (DC+, DC−, PE, CP) are customarily arranged on the roof of the electric vehicle 10, in the longitudinal direction. Four contact rails 21, 22, 23, 24 for the four connections (DC+, DC−, PE, CP) are also arranged on the pantograph 20, but in the transverse direction rather than in the longitudinal direction. However, other arrangements are also conceivable. Consequently, one contact rail respectively is provided for each connection. FIG. 3 shows only a schematic representation of the pantograph 20 and the electric vehicle 10, and only parts thereof are represented, namely the contact rails of the pantograph 20 and the roof of the electric vehicle 10 having the contact rails. After the lowering of the pantograph 20 in the direction of the electric vehicle 10, it is necessary for the contact rails 21, 22, 23, 24 of the pantograph 20 to be connected to the contact rails 11, 12, 13, 14 of the electric vehicle 10 before the charging process can be initiated.

The four different connections are also described as contacts, and are defined as follows:

The connection DC+ forms the connection between the positive pole of the accumulator in the electric vehicle and the positive terminal of the voltage source of the charging infrastructure.

The connection Dc− forms the connection between the negative pole of the accumulator in the electric vehicle and the negative terminal of the voltage source of the charging infrastructure.

The connection PE forms the connection between the bodywork of the electric vehicle and the ground potential of the charging infrastructure.

The connection CP carries a signal which can be influenced and evaluated by the electric vehicle and the charging station, thus permitting the direct detection of a connection between this pair of rails and therefore, in conjunction with a corresponding mechanical build-up, the indirect detection of the connection between the further pairs of rails.

During the positioning process, it is necessary for the contact rails 11, 12, 13, 14 of the electric vehicle 10 to be arranged relative to the contact rails 21, 22, 23, 24 of the pantograph 20 such that said rails overlap at corresponding contact points 31, 32, 33, 34.

The overhead view of the roof of the electric vehicle 10, upon which the contact rails 11, 12, 13, 14 are arranged in the longitudinal direction, is represented in FIG. 4. The contact rails 11, 12, 13, 14 of the electric vehicle 10 overlap with the contact rails 21, 22, 23, 24 of the pantograph 20 at the four contact points 31, 32, 33, 34, as represented.

Correspondingly, during the positioning process, it must be observed that the contact rails 11, 12, 13, 14 of the electric vehicle 10 are not brought into contact with just any of the contact rails 21, 22, 23, 24 of the pantograph 20, but only with the respective corresponding rail. For example, the contact rail 11 for the connection DC+ of the electric vehicle 10 should also be connected to the corresponding contact rail 21 for the connection DC+ of the pantograph 20. For each contact rail 11, 12, 13, 14 on the electric vehicle 10, there is therefore a contact rail 21, 22, 23, 24 with a corresponding functionality on the pantograph 20. Consequently, in the present example, there are a total of four contact points 31, 32, 33, 34 for the four connections DC+, DC−, PE, CP, where eight contact rails are provided. The four pairs of rails are thus entirely independent, with respect to mechanical contact.

By means of the contacts, it should be ensured that:

a) An accumulator located in the electric vehicle can be connected on both poles to a voltage source of the charging infrastructure which is connected to the charging point

b) The electric vehicle is grounded, and the ground connection has a current-carrying capacity which is sufficient to accommodate the maximum possible fault current, in the event of a ground fault

c) The electric vehicle and the control system associated with the charging point can independently detect an interruption in the connection of the contact rails which may occur, for example, in the event of the raising of the pantograph or the pulling away of the bus.

During the positioning process, moreover, the electric vehicle can only be positioned within a predefined tolerance window. The largest possible tolerance window is desirable, in order to permit the correct positioning of the electric vehicle with a high degree of probability. The tolerance window is geometrically defined in consideration of the number of connections to be formed, customarily four, between the electric vehicle 10 and the pantograph 20.

FIG. 5 shows an overview of the respective tolerance windows for the four contact points. The arrangement of the contact rails in FIG. 5 is selected such that the contact rails 21, 22, 23, 24 of the pantograph 20 and the contact rails 11, 12, 13, 14 of the electric vehicle 10 simultaneously intersect in pairs at the mid-points 31, 32, 33, 34. Accordingly, the length of the tolerance window is: min (x_{a . . .d}) and the height min (y_{a . . .d}), where:

yᵢ=l₂ᵢ−bₗᵢ for i ϵ {a, b, c, d}.

Thus, in the event of the positioning of the electric vehicle with no angular error:
l₁ᵢ is the length of the i^{th} contact rail oriented in the x-direction
l₂ᵢ is the length of the i^{th} contact rail oriented in the y-direction
b₁ᵢ is the width of the i^{th} contact rail oriented in the x-direction
b₂ᵢ is the width of the i^{th} contact rail oriented in the y-direction.
In the event of positioning with an angular error, the following values are calculated:

l₁ᵢ=l′₁ᵢ−0.5 tan(α)·dx

l₂ᵢ=l′₂ᵢ−0.5 tan(α)·dy

b₁ᵢ=b′₁ᵢ±0.5 tan(α)·b′₂ᵢ

b₂ᵢ=b′₂ᵢ±0.5 tan(α)·b′₁ᵢ

One disadvantage of the conventional tolerance windows which are known from the prior art, as represented in FIG. 5, is their respective size. The tolerance windows are not sufficiently large for a correct and accurate positioning of the electric vehicle. As a result of the restricted size of the tolerance windows, it is necessary for the contact rails 11, 12, 13, 14 of the electric vehicle 10 and the corresponding contact rails 21, 22, 23, 24 of the pantograph 20 to be very accurately arranged and positioned in relation to one another.

The process will once again be described in detail hereinafter. During the positioning process, the pantograph 20 is firstly lowered onto the roof of the electric vehicle 10, in order to form the four contact points 31, 32, 33, 34 for the four connections. However, the formation of the connections can only be assured to an insufficient extent. If this positioning process fails, and the connections cannot be formed as required, it is necessary for the pantograph 20 to be raised once more, by a complex operation, and for the positioning process to be repeated. In this case, the positioning process will start again from scratch. This means that the electric vehicle 10 must again be arranged vis-à-vis the pantograph 20, and the pantograph 20 must again be lowered onto the roof of the electric vehicle 10. To this end, for example, it is necessary for the electric vehicle to be newly maneuvered and brought into a different parking position below the pantograph. The positioning process from the prior art is thus highly disadvantageous, in that it is complex and time-intensive. In bus operation, moreover, any maneuvering at a bus stop will be difficult to understand from the viewpoint of the final customer, namely the passenger. In the event that passengers who wish to travel are able to board the bus in anticipation, any repositioning of the bus without the endangerment of persons is prevented, at least temporarily.

It is additionally disadvantageous that the positioning process is a precondition for the further charging process. The charging process cannot be initiated until positioning has been successfully completed, i.e. further to the establishment of the connections between the electric vehicle and the pantograph.

Throughout the entire positioning process, and the subsequent charging process, the electric vehicle cannot be correctly operated in the sense that, firstly, the passengers are required to remain in the bus, and are secondly delayed in their arrival at their destination. This results in huge time delays in operational procedure, the unnecessary lengthening of journey times and a corresponding increase in costs.

### SUMMARY

An aspect relates to therefore the formation of a connection of the connecting unit for connection to the electric vehicle in an efficient, cost-saving and simple manner.

An aspect relates to a connecting unit for connection to an electric vehicle, comprising:
a. at least two contact rails, wherein
b. the at least two contact rails are arranged with a clearance from one another, wherein the clearance between the at least two contact rails is smaller than between two mechanically independent contact rails, wherein
c. the at least two contact rails can be connected to a corresponding first vehicle-side contact rail of the electric vehicle;
d. a third contact rail, wherein
e. a signal can be applied to the third contact rail, and
f. the one third contact rail can be connected to a corresponding second vehicle-side contact rail of the electric vehicle.

As already described above, a connecting unit of a charging infrastructure and the electric vehicle respectively comprise contact rails. The electric vehicle is to be understood as an at least partially electrically-powered vehicle which, additionally to the electric drive, can also be propelled by other means, for example by means of a combustion engine. The contact rails are matched in relation to one another such that the contact rails of the connecting unit, after the lowering of the connecting unit in the direction of the electric vehicle, mutually overlap with the contact rails of the electric vehicle at the contact points, thereby permitting the formation of the four connections (DC+, DC−, PE, CP). In the prior art, four contact points are required for the formation of the four connections. Disadvantageously, however, the size of the corresponding tolerance windows for the respective contact points is very small.

The connecting unit comprises two or a plurality of contact rails. For example, one contact rail is provided for the connection DC+ and one contact rail is provided for the connection DC−. These contact rails are dependent upon one another, to a certain degree, on account of the positive and negative polarity. Consequently, the contact rails are not arranged in any desired manner, but rather with a specific clearance from one another. This clearance is defined such that said clearance is smaller than the clearance between two mechanically independent contact rails. Accordingly, the contact rails are arranged in the immediate vicinity of one another, preferably also in the longitudinal direction. However, the chosen clearance should also not be so small that it might potentially result in an unwanted short-circuit. The contact rails can be connected to a corresponding vehicle-side contact rail of the electric vehicle. Correspondingly, on the electric vehicle side, advantageously only one contact rail rather than two is required for the formation of the two connections DC+, DC− with the connecting unit.

The connecting unit further comprises a further contact rail, to which a signal can be applied. The contact rail can be connected to a corresponding vehicle-side contact rail of the electric vehicle. By the application of a signal, the contact rail is endowed with an additional monitoring functionality for the monitoring of the contact between the contact rails of the electric vehicle and the contact rails of the connecting unit. Correspondingly, on the electric vehicle side, only one contact rail rather than two is required for the formation of the connections PE, CP with the connecting unit.

Advantageously, by means of the connecting unit according to embodiments of the invention, the number of four contact points from the prior art is reduced to two contact points, and the size of the respective tolerance windows is increased.

In one configuration, the connecting unit is configured as a pantograph. Correspondingly, the connecting unit can be, for example, a pantograph or a charging cable. In one configuration, an electric bus is connected to a pantograph, and is charged by means of a pantograph.

In a further configuration, the electric vehicle is configured as an electric bus. Correspondingly, the electric vehicle can be, for example, an electric bus, an electric car, an electric vehicle, etc. The electric bus can be employed for local traffic duties, and is charged by means of a corresponding charging station of the charging infrastructure.

In a further configuration, the at least two contact rails are configured as a twin contact. Correspondingly, a small clearance between the two contact rails for the connections is chosen such that, on the connecting unit side, only one twin contact is required, rather than two contact rails. Consequently, the twin contact can also advantageously overlap with a corresponding vehicle-side contact rail at only one contact point, rather than two.

In a further configuration, a positive voltage is present on a first of the at least two contact rails, and a negative voltage is present on a second of the at least two contact rails. As already described above, the two contact rails of the connecting unit are specifically provided for the connections DC+ and DC−. The clearance between the contact rails is selected in accordance with their polarity and their composition. Alternatively, however, the contact rails can also be configured for other connections or functionalities, for example the connection CP or PE, and the clearance can be adapted accordingly.

In a further configuration, the third contact rail is a ground rail, upon which a high-frequency and/or an interference-resistant signal is modulated. Accordingly, the further contact rail of the connecting unit is provided for the connections PE and CP. Consequently, one contact rail for the implementation of two connections is saved. The additional and customary contact rail from the prior art for the connection CP is thus omitted. The third contact rail, in addition to its protection function, thus likewise has a capability for the monitoring of the connection between the contact rails on the vehicle side and the contact rails on the connecting unit side.

In a further configuration, the corresponding first vehicle-side contact rail of the electric vehicle comprises a plurality of segments. The first vehicle-side contact rail of the electric vehicle is correspondingly subdivided into segments.

In a further configuration, the polarity and/or another function of each segment of the plurality of segments is not predefined. Accordingly, the connection for which the respective segments of the contact rail are employed is not established beforehand. The respective segment can therefore be employed as required, for example, for the connection DC+ or DC−. Consequently, and advantageously, the twin contact of the connecting unit can also be connected to the respective segment as required. The subdivision of the contact rails into positive and negative polarities is therefore omitted. As a result, on the electric vehicle side, only one contact rail for the connection to the twin contact on the connecting unit side is advantageously required, rather than two contact rails for the connections DC+ and DC−.

In a further configuration, each segment of the plurality of segments comprises at least two different segment sections, specifically one conductive and one insulating segment section. On the grounds that the polarity of the segments is not predefined, the segments are subdivided into conductive and insulating sections. A short-circuit is advantageously prevented accordingly.

In a further configuration, the length of the insulating segment section is greater than the respective width of the at least two contact rails. This dimensioning ensures that the two contact rails of the connecting unit can never simultaneously engage with the same conductive section, thereby preventing a short-circuit. By means of this advantageous dimensioning, the contact rails can be arranged more compactly, and thus in a space-saving manner. Additionally, complexity of manufacture is significantly reduced, thereby saving costs. Consequently, the size of the tolerance window can be increased. Alternatively or additionally, other dimensioning arrangements and dimensional proportions may be chosen. For example, the lengths of the insulating and conductive segment sections could be configured such that the sum of two insulating segment sections and one conductive segment section exceeds the width of the contact rail.

In a further configuration, the length of the conductive segment section corresponds to the clearance between the at least two contact rails. By means of this advantageous dimensioning, the contact rails can be arranged more compactly, and thus in a space-saving manner. Additionally, complexity of manufacture is significantly reduced, thereby saving costs.

In a further configuration, each segment of the plurality of segments is connected via at least one diode respectively to one of the at least two contact rails for the application of a positive voltage or for the application of a negative voltage.

Embodiments of the invention is further directed to a method for the connection of a connecting unit to an electric vehicle, comprising:
a. The arrangement of at least two contact rails with a clearance from one another, wherein the clearance between the at least two contact rails is smaller than between two mechanically independent contact rails,
b. The connection of the at least two contact rails to a corresponding first vehicle-side contact rail of the electric vehicle,
c. The application of a signal to the third contact rail, and
d. The connection of the third contact rail to a corresponding second vehicle-side contact rail of the electric vehicle.

Embodiments of the invention is also directed to an electric vehicle for connection to a connecting unit, comprising:
a. a first vehicle-side contact rail, wherein
b. the first vehicle-side contact rail can be connected to the corresponding two contact rails of the connecting unit such that the at least two contact rails remain isolated from one another,
c. a second vehicle-side contact rail, wherein
d. a signal can be applied to the second vehicle-side contact rail, and the second vehicle-side contact rail can be connected to a third contact rail of the connecting unit.

### BRIEF DESCRIPTION OF THE DRAWINGS

Some of the embodiments will be described in detail, with reference to the following figures, wherein like designations denote like members, wherein:

FIG. 1 shows a representation of an electric vehicle for connection to a connecting unit, in accordance with embodiments of the present invention;

FIG. 2 shows a detailed view of contact rails of the electric vehicle and those of the connecting unit, in accordance with embodiments of the present invention;

FIG. 3 shows an exemplary device from the prior art for the charging of an electric bus by means of a pantograph;

FIG. 4 shows an overhead view of the roof of the electric bus with its contact rails, which intersect with each of the contact rails of the pantograph at the contact points, according to the prior art; and

FIG. 5 shows the tolerance windows for the contact points, according to the prior art.

### DETAILED DESCRIPTION

Forms of embodiment of the present invention are described hereinafter with reference to the accompanying figures.

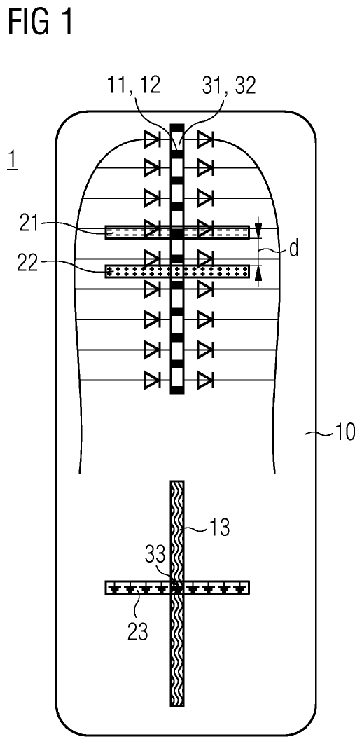

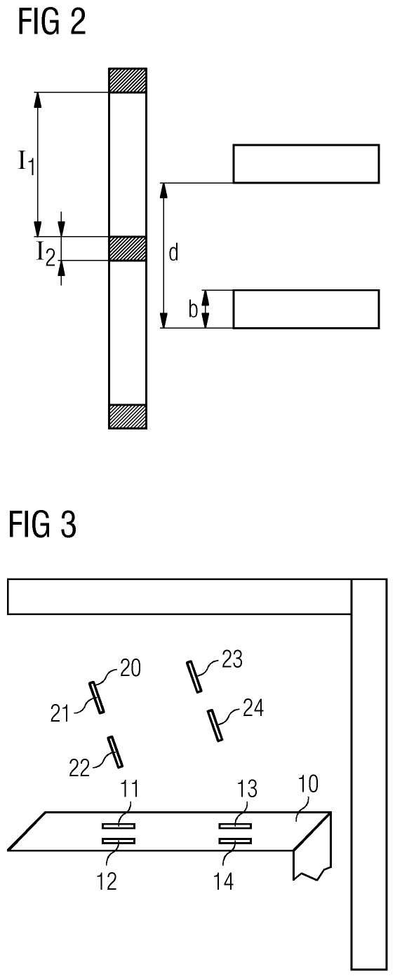

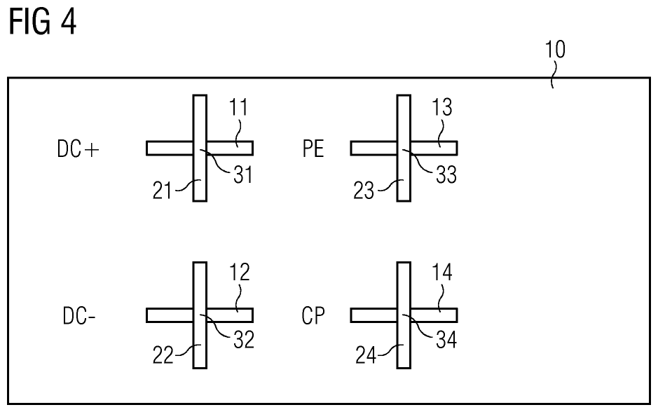

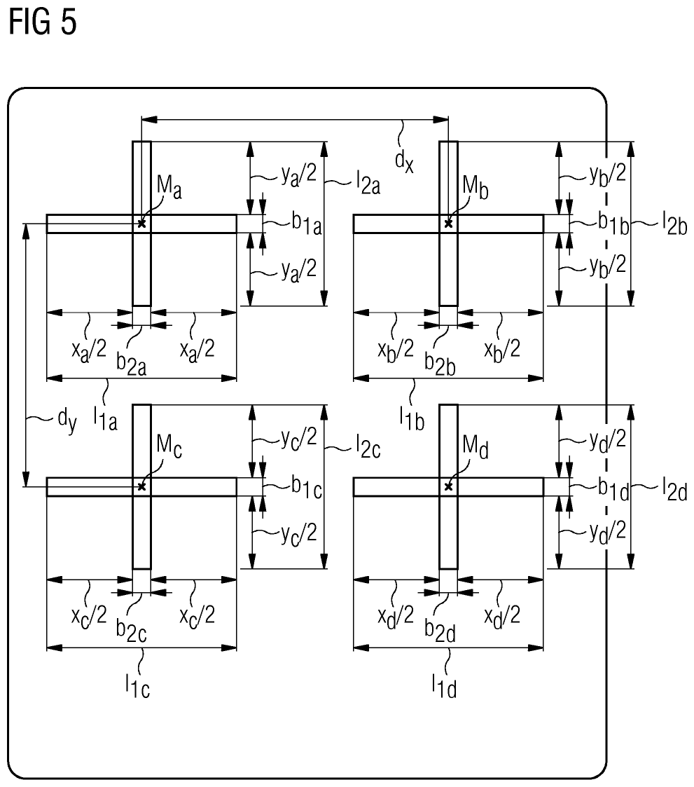

FIG. 1 represents an electric vehicle 10 according to embodiments of the invention. The electric vehicle 10 can be configured, for example, as an electric bus. However, other electric vehicles are also possible, as mentioned above. The electric vehicle 10 comprises a roof which, for the purposes of illustration in an overhead view, is shown in a rectangular form. A contact rail 11, 12 is fitted to the roof of the electric vehicle 10. The contact rail 11, 12 comprises a plurality of segments. The individual segments in FIG. 1 are subdivided into two different segment sections, which are represented in black and white. The white segment section is configured as conductive, and the black segment section is configured as insulating. Alternatively or additionally, further segment sections can be provided. Advantageously, the polarity of any given segment of the contact rail 11, 12 is not predetermined. Accordingly, conversely to the prior art, only one rather than two contact rails is provided on the side of the electric vehicle 10.

The connecting unit further comprises two contact rails. For example, the connecting unit 20 is a pantograph. The first contact rail 21 is provided for the connection DC+. The second contact rail 22 is provided for the connection DC−. The two contact rails 21, 22 of the connecting unit 20 are positioned in close proximity, and are thus advantageously configured as a twin contact. The twin contact can be arranged at any desired location on the contact rail 21, 22. The one contact rail 11, 12, with the segments of the electric vehicle 10, can overlap with the contact rails 21, 22 of the connecting unit 20 at a contact point 31, 32.

The dimensions of this contact rail, and of the two constituent rails of a contact point on the connecting unit 10, are coordinated such that the following condition is fulfilled:

l₂>b

wherein, in an optimum embodiment
i. l1=d for i ϵ IN, where i=1
would be chosen. Herein, 12 is the length of the insulating segment section of the corresponding vehicle-side contact rail 11, 12 of the electric vehicle 10, 11 is the length of the conductive segment section of the corresponding vehicleside contact rail 11, 12 of the electric vehicle, and d is the clearance between the first and second contact rails 21, 22 of the pantograph.

On the roof of the electric vehicle 10, a contact rail 13 is additionally fitted, which can overlap with a corresponding third contact rail 23 of the connecting unit 20. Additionally, further contact rails can be fitted to the roof of the electric vehicle 10 and/or to the connecting unit 20.

The third contact rail of the electric vehicle 10 is connected to the vehicle bodywork (ground), and can connect the vehicle to the ground potential. Moreover, a signal, for example a high-frequency and/or interference-resistant signal, can also be modulated thereupon. Additionally or alternatively, an infrastructure-side modulated signal can be received. The third contact rail of the connecting unit 20 is connected to the ground potential. A signal is applied here by the control circuit of the charging point, and a check is moreover executed as to whether a signal is applied by the bus. The signal is modulated upon the ground rail 13. This signal constitutes a defined character string for individual messages, and can also be evaluated without the involvement of a CPU.

Conversely to the prior art, no further contact rail 14 is provided for the connection CP on the roof of the electric vehicle 10. The function of the connection CP is the monitoring of the contact between the contact rails 11, 12, 13 on the electric vehicle and the contact rails 21, 22, 23 on the pantograph 20. This monitoring functionality is transferred to the ground rail. Accordingly, the ground rail, in addition to the protection function for the exchange of information, is also equipped with the monitoring functionality. This means that, in other words, monitoring of the ground rail is advantageously executed directly, conversely to the prior art, in which monitoring is executed indirectly, wherein the contact of CP is lost when one of the other contacts is lost. This has previously been executed, for example, by mechanical means.

During the positioning process, the pantograph 20 is lowered in the direction of the roof of the electric vehicle 10, in order to connect the contact rails 11, 12, 13 of the electric vehicle 10 to the contact rails 21, 22, 23 of the pantograph 20.

To this end, firstly, the segments of the contact rail 11, 12 of the electric vehicle 10, via one or more diodes, are connected to the negative or positive potential of the contact rail 21, 22 of the pantograph 20. Moreover, the contact rail 13 of the electric vehicle 10 is connected to the ground rail 23 of the pantograph 20. For example, the connection can be constituted by way of coupling capacitors. By means of the arrangement of the contact rails according to embodiments of the invention, the latter only overlap at two contact points 31, 32 and 33.

The contact rails can be configured as copper conductors, and can be arranged as required in the longitudinal direction or in the transverse direction. However, other arrangements or configurations of the contact rails on the electric vehicle or on the connecting unit are also conceivable. Alternatively, for example, the orientation or composition of the contact rails could be varied.

As already described above, a conventional arrangement of the contact rails according to the prior art requires four contact points. By means of the advantageous arrangement of the contact rails according to embodiments of the invention on the electric vehicle 10 and on the connecting unit 20, respectively, and the coordinated overlap thereof, the number of contact points 31, 32, 33, 34 is reduced from four to two contact points 31, 32 and 33. The number is thus halved. As a result, the width of the tolerance window is also increased two-fold, such that the translational tolerance is also increased two-fold.

The two contact points 31, 32 and 33 are, inevitably, arranged in a line. As a result, moreover, the maximum rotational tolerance is significantly increased.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A connecting unit for connection to an electric vehicle, comprising:
at least two contact rails, wherein: the at least two contact rails are arranged with a clearance from one another, wherein the clearance between the at least two contact rails being smaller than between two mechanically independent contact rails, and the at least two contact rails are connected to a corresponding first vehicle-side contact rail of the electric vehicle; and
a third contact rail, wherein a signal is applied to the third contact rail, the third contact rail being connected to a corresponding second vehicle-side contact rail of the electric vehicle.

2. The connecting unit as claimed in claim 1, wherein the connecting unit is configured as a pantograph.

3. The connecting unit as claimed in claim 1, wherein the electric vehicle is an electric bus.

4. The connecting unit as claimed in 1, wherein the at least two contact rails are configured as a twin contact.

5. The connecting unit as claimed in claim 1, wherein a positive voltage is present on a first contact rail of the at least two contact rails, and a negative voltage is present on a second contact rail of the at least two contact rails.

6. The connecting unit as claimed in claim 1, wherein the third contact rail is a ground rail, upon which a high-frequency and/or an interference-resistant signal is modulated.

7. The connecting unit as claimed in claim 1, wherein the corresponding first vehicle-side contact rail of the electric vehicle comprises a plurality of segments.

8. The connecting unit as claimed in claim 7, wherein the polarity and/or another function of each segment of the plurality of segments is not predefined.

9. The connecting unit as claimed in claim 7, wherein each segment of the plurality of segments comprises at least two different segment sections, specifically one conductive segment section and one insulating segment section.

10. The connecting unit as claimed in claim 9, wherein a length of the insulating segment section is greater than a respective width of the at least two contact rails.

11. The connecting unit as claimed in claim 9, wherein a length of the conductive segment section corresponds to the clearance between the at least two contact rails.

12. The connecting unit as claimed in claim 8, wherein each segment of the plurality of segments is connected via at least one diode respectively to one of the at least two contact rails for an application of a positive voltage or for an application of a negative voltage.

13. A method for the connection of a connecting unit to an electric vehicle, comprising:
arranging at least two contact rails with a clearance from one another, wherein the clearance between the at least two contact rails is smaller than between two mechanically independent contact rails,
connecting the at least two contact rails to a corresponding first vehicle-side contact rail of the electric vehicle,
applying a signal to the third contact rail; and
connecting a third contact rail to a corresponding second vehicle-side contact rail of the electric vehicle.

14. An electric vehicle for connection to a connecting unit, comprising:
a first vehicle-side contact rail, wherein the first vehicle-side contact rail is connected to the corresponding two contact rails of the connecting unit such that the at least two contact rails remain isolated from one another; and
a second vehicle-side contact rail, wherein a signal applied to the second vehicle-side contact rail, and the second vehicle-side contact rail is connected to a third contact rail of the connecting unit.
